(19) United States
(12) Patent Application Publication
(10) Pub. No.: US 2014/0067340 A1
(43) Pub. Date: Mar. 6, 2014

(54) METHOD FOR DESIGNING CYLINDER DEVICE AND CYLINDER DEVICE

(71) Applicant: Shuuichi Buma, Toyota-shi (JP)

(72) Inventor: Shuuichi Buma, Toyota-shi (JP)

(73) Assignee: TOYOTA JIDOSHA KABUSHIKI KAISHA, Toyota-shi, Aichi (JP)

(21) Appl. No.: 14/110,820

(22) PCT Filed: May 17, 2011
(86) PCT No.: PCT/JP2011/061278

§ 371 Date: Oct. 9, 2013

(51) Int. Cl. F16F 9/19; F16F 9/30

(52) U.S. Cl. CPC F16F 9/19; F16F 9/30
USPC 703/1

(57) ABSTRACT

In designing a cylinder device serving as a colloidal damper, containing working liquid and a porous body having pores, and provided between two objects arranged in an up/down direction and movable relative to each other, a reference cracking pressure Pᵢₙₜᵣ′ that is an indication of a cracking pressure Pᵢₙₜᵣ as an internal pressure in a chamber at the start of a flow of the working liquid into the pores is set according to the weight of an upper one of the two objects, and a reference pore diameter d′(=2·r′) that is an indication of a pore diameter d is determined based on the reference cracking pressure Pᵢₙₜᵣ′ and based on the following equation: Pᵢₙₜᵣ==2·σ·cos θᵢₙ/r (where σ is a surface tension of the working liquid, and θᵢₙ a contact angle of the working liquid upon its penetration).

### TECHNICAL FIELD

The present invention relates to a method for designing a cylinder device serving as a colloidal damper, containing working liquid and a porous body having pores, and provided between two objects which are arranged in an up and down direction and which move relative to each other and relates to a cylinder device serving as a colloidal damper designed according to the designing method.

### BACKGROUND ART

Cylinder devices described in patent documents below contain a colloidal solution composed of a porous body and working liquid such as a hydrophobized porous silica gel and are configured to expand and contract with flows of the working liquid into and out of pores of the porous body. In each cylinder device, the working liquid flows into the pores against a surface tension. Thus, a pressure in the cylinder device rises with the flow of the working liquid into the pores. Also, the cylinder device serves as a damper configured to dissipate energy applied from outside, by utilizing repeated flows of the working liquid into and out of the pores of the porous body under the surface tension. The cylinder device that contains the colloidal solution is called a colloidal damper and has characteristics described above.

Such a colloidal damper is configured such that the pressure in the cylinder device rises with the flow of the working liquid into the pores of the porous body as described above. Thus, this colloidal damper can support an object coupled to an upper side of the cylinder device, by utilizing the pressure in the cylinder device in the state in which the working liquid is in the pores of the porous body.

### PRIOR ART DOCUMENTS

### Patent Documents

Patent Document 1: JP-A-2006-118571

Patent Document 2: JP-A-2004-44732

### SUMMARY OF THE INVENTION

### Problem to be Solved by the Invention

The above-described cylinder device serving as the colloidal damper and a spring preferably has characteristics required depending upon an object supported by the device, a situation of use of the device, and the like. That is, designing and achieving the cylinder device having characteristics required depending upon the situation of use of the device are considered to improve utility of the cylinder device serving as the colloidal damper and the spring. The present invention has been developed in view of the above-described situations, and it is an object of the present invention to provide a cylinder device serving as a colloidal damper having high utility and, in order to achieve the cylinder device having high utility, provide a method for designing the cylinder device having characteristics required depending upon, e.g., the situation of use of the device.

### Means for Solving Problem

To solve the above-described problems, in a method for designing a cylinder device according to a first aspect of the present invention, a reference cracking pressure that is an indication of a cracking pressure as an internal pressure in a chamber at a start of a flow of working liquid into pores of a porous body is set according to the weight of an upper one of two objects which move relative to each other, and a reference pore diameter that is an indication of a pore diameter of the porous body is determined based on the reference cracking pressure and using a relationship between the pore diameter of the porous body and the cracking pressure determined based on a balance the internal pressure in the chamber and an internal pressure in the pore of the porous body.

Also, in a method for designing a cylinder device according to a second aspect of the present invention, a bulk modulus of the working liquid, a pressure receiving area of a piston, and an initial-compression spring constant that is a rate of change in an internal pressure in a chamber with respect to an amount of stroke performed by the cylinder device until working liquid starts to flow into pores of a porous body are set, and an amount of the working liquid is determined based on the set bulk modulus of the working liquid, the set pressure receiving area of the piston, and the set initial-compression spring constant and using a relationship in which the initial-compression spring constant is equal to a value obtained by dividing, by the amount of working liquid, a product of the bulk modulus of the working liquid and a square of the pressure receiving area of the piston.

Also, in a method for designing a cylinder device according to a third aspect of the present invention, an initial-compression spring constant, a pressure receiving area of a piston, a capacity of a housing, and a volume of a porous body are set, and a bulk modulus calculated based on the same relationship as in the second aspect of the invention is determined as a designed bulk modulus based on the set pressure receiving area of the piston, the set initial-compression spring constant, and a capacity obtained by subtracting the volume of the porous body from the capacity of the housing, and a material to be contained in the chamber and having a bulk modulus which differs from that of the working liquid is determined to adjust a bulk modulus of the chamber to the designed bulk modulus.

Also, a cylinder device according to a fourth aspect of the present invention is configured to contain, in a chamber, a material whose bulk modulus is lower than that of water as working liquid. A cylinder device according to a fifth aspect of the present invention includes a sub-housing coupled to a housing such that an inside of the sub-housing communicates with an inside of the housing to form a chamber, and the capacity of the sub-housing is equal to or greater than 46 percent and equal to or less than 100 percent of a capacity that is obtained by subtracting the volume of a porous body from the capacity of the housing.

### Effect of the Invention

In the three methods for designing the cylinder device according to the first to third aspects of the present invention, any of the cracking pressure and the initial-compression spring constant as the characteristics of the colloidal damper can be made appropriate for the situation of use of the device, and so on. That is, the cylinder device designed according to the designing methods of the present invention has high utility. It is noted that the cylinder device according to the above-described fourth aspect is suitable for achieving the designed bulk modulus determined by the method for designing the cylinder device according to the above-described third aspect. The cylinder device according to the above-described fifth aspect is suitable for containing the working liquid having the amount determined by the method for designing the cylinder device according to the above-described third aspect.

### Forms of the Invention

There will be described various forms of the invention which is considered claimable (hereinafter referred to as “claimable invention” where appropriate). Each of the forms of the invention is numbered like the appended claims and depends from the other form or forms, where appropriate. This is for easier understanding of the claimable invention, and it is to be understood that combinations of constituent elements that constitute the invention are not limited to those described in the following forms. That is, it is to be understood that the claimable invention shall be construed in the light of the following descriptions of the various forms and the embodiments. It is to be further understood that any form in which one or more elements is/are added to or deleted from any one of the following forms may be considered as one form of the claimable invention.

It is noted that the following form (1) does not indicate a designing method according to the claimable invention but indicates a construction as a base of a cylinder device to be designed according to the method, and a form in which technical features in any of the forms (2)-(11) are added to the form (1) corresponds to a designing method of the claimable invention. Among the various forms of the claimable invention, the form (5) depending from the form (1) corresponds to claim 1, and a form in which technical features of the form (6) are added to claim 1 corresponds to claim 2. A combination of the forms (1), (8), and (10) corresponds to claim 3, a combination of the forms (1), (8), and (11) corresponds to claim 4, and a form in which technical features of the form (9) are added to claim 3 or 4 corresponds to claim 5.

The following form (21) does not indicate a cylinder device according to the claimable invention but indicates a construction as a base of the claimable invention, and a form in which technical features of any of the form (22)-(28) are added to the form (21) corresponds to the claimable invention. Among the various forms of the claimable invention, a combination of the forms (21), (22), and (23) corresponds to claim 6, and a form in which technical features of the form (25) are added to claim 6 corresponds to claim 7. A combination of the forms (21); (26), and (27) corresponds to claim 8. A form in which technical features of the form (28) are added to any of claims 6-8 corresponds to claim 9.

(1) A method for designing a cylinder device serving as a colloidal damper, the cylinder device comprising (A) a housing coupled to one of two objects which move relative to each other, (B) a piston coupled to another of the two objects and slidable in the housing, and (C) a porous body and working liquid contained inside a chamber defined by the housing and the piston, the porous body having a multiplicity of pores, the cylinder device being configured to (i) support an upper one of the two objects depending upon an internal pressure in the chamber which is produced by a state in which the working liquid has flowed in the multiplicity of pores of the porous body and (ii) damp relative movement between the two objects by utilizing a change in an amount of the working liquid flowing in the multiplicity of pores of the porous body, the change being caused by the relative movement between the two objects.

As explained above, the present form indicates the construction as the base of the cylinder device to be designed by the method according to the claimable invention. That is, the designing method described above is a form including fundamental constituent elements of the colloidal damper to be designed by the method according to the claimable invention. Methods for designing the cylinder device described below can widely apply to a colloidal damper that has a construction having been studied.

The cylinder device, in the present form, containing the colloidal solution comprising the porous body and the working liquid is called a colloidal damper and configured to dissipate energy applied from outside, by utilizing repeated flows of the working liquid into and out of the pores of the porous body under a surface tension. The colloidal damper is further configured such that the pressure in the chamber rises with the flow of the working liquid into the pores of the porous body. Thus, the object located on the upper side of the colloidal damper can be supported by the internal pressure in the chamber in the state in which the working liquid has flowed in the porous body, that is, the colloidal damper can serve as a spring. In a case where the cylinder device is used in this manner, it is preferable that characteristics of the cylinder device are appropriately set according to the weight of the upper object and a degree of the relative movement between the two objects (e.g., amplitude and a frequency). That is, a method for designing the cylinder device is essential to set the characteristics of the cylinder device serving as a colloidal damper.

The cylinder device described in the present form uses the colloidal solution comprising the porous body and the working liquid. Types of the porous body and the working liquid are not limited in particular, but the porous body and the working liquid preferably have a low affinity for each other and are not easily bonded to each other, in plain words, it is preferable that the porous body is not easily dissolved in the working liquid. The porous body may be a particulate matter (i.e., a micro-particle or grain) of the order of micrometers (μm) which has a pore or pores of the order of nanometers (nm). Examples of the porous body include: a lyophobic material not easily soluble; and a lyophobic-coated material. Specifically, the porous body can be composed of silica gel, aero gel, ceramics, zeolite, porous glass, and porous polystyrene, for example. Also, examples of the working liquid include: water; a mixture of water and antifreeze liquid such as ethanol, ethylene glycol, propylene glycol and glycerin; mercury; and a molten metal. It is noted that water has a relatively high surface tension, and accordingly in a case where water is used as the working liquid, the colloidal damper produces a large force due to the high surface tension when water flows into or out of the pore of the porous body. It is noted that in the case where water is used as the working liquid, the porous body preferably is a material having a low affinity for water or a hydrophobized material as described above.

(2) The method for designing the cylinder device according to the above form (1),

wherein the two objects are a vehicle body and a wheel holder configured to hold a wheel rotatably,

wherein the housing is coupled to one of the vehicle body and the wheel holder, and the piston is coupled to another of the vehicle body and the wheel holder,

wherein the cylinder device is a suspension cylinder constituting a suspension device for a vehicle and configured to suspend the vehicle body, and

wherein the method for designing the cylinder device is a method for designing the cylinder device as the suspension cylinder.

In the designing method described in the present form, a cylinder device to be designed is one constituent element of the suspension device for a vehicle. Specifically, the designing method described in the present form is a method for designing a cylinder device that serves as a shock absorber configured to damp relative movement between the vehicle body and the wheel holder.

(3) The method for designing the cylinder device according to the above form (1) or (2), wherein the working liquid is water.

(4) The method for designing the cylinder device according to the above form (3), wherein the porous body is a hydrophobized porous silica gel.

The forms described in the above-described two forms define the working liquid and the porous body used for the cylinder device. As described above, water has a high surface tension and is preferable as the working liquid used for the colloidal damper. In a case where water is used as the working liquid, the porous body preferably is hydrophobic, and the latter form is a preferable form thereof.

(5) The method for designing the cylinder device according to any one of the above forms (1) through (4), the method comprising:

a cracking pressure setting process in which a reference cracking pressure is set according to a weight of the upper one of the two objects, wherein the reference cracking pressure is an indication of a cracking pressure that is an internal pressure in the chamber at a timing when the working liquid starts to flow into the multiplicity of pores of the porous body; and

a pore diameter determination process in which a reference pore diameter that is an indication of a pore diameter of the porous body is determined based on the reference cracking pressure and using a relationship between the pore diameter of the porous body and the cracking pressure determined based on a balance between the internal pressure in the chamber and an internal pressure in the multiplicity of pores of the porous body.

When a force is applied to the cylinder device, a hydraulic pressure of the working liquid rises in the colloidal solution contained in the chamber. When the hydraulic pressure of the working liquid has risen to a certain pressure, the working liquid flows into the pores of the porous body against the surface tension of the working liquid. The method described above sets, to an appropriate magnitude, the internal pressure in the chamber at the start of the flow of the working liquid into the pores of the porous body, that is, the method sets the above-described cracking pressure to the appropriate magnitude. It is noted that conventional studies and experiments have found that the common colloidal damper has a characteristic in which the internal pressure in the chamber and an amount of stroke of the cylinder device have a linear relationship in a certain range after the internal pressure in the chamber reaches the cracking pressure. Thus, determination of the cracking pressure determines an approximate magnitude of a force to be produced by the cylinder device to support the upper object. Also, the force to be produced by the cylinder device to support the upper object is determined by the internal pressure in the chamber and the pressure receiving area of the piston. That is, in the cracking pressure setting process in the present form, the reference cracking pressure is set to any pressure, and an indication of the pressure receiving area of the piston can be set based on the reference cracking pressure and the weight of the upper object. As explained in detail later, the indication of the pressure receiving area of the piston may be set to set the reference cracking pressure based on the indication and the weight of the upper object.

The cracking pressure and the pore diameter of the porous body have the relationship that is determined based on the balance of the internal pressure in the chamber and the internal pressure in the pores of the porous body. It is noted that the internal pressure in the pores of the porous body is dependent upon the surface tension of the working liquid, and this surface tension of the working liquid is determined by a contact angle and a pore diameter of the working liquid. That is, determination of the working liquid can determine the pore diameter of the porous body by setting the reference cracking pressure. In other words, adjustment of the pore diameter of the porous body can adjust the cracking pressure. It is noted that since a value determined in the pore diameter determination process in the present form is only a value of the indication, a porous body having a pore diameter close to the reference pore diameter can be actually used for the cylinder device, for example. Where the porous body having the reference pore diameter exists and where the porous body having the reference pore diameter is actually used for the cylinder device, the reference pore diameter is exactly equal to a design value. It is noted that where the porous body having the reference pore diameter is actually used for the cylinder device, the reference cracking pressure based on which the reference pore diameter is determined is also equal to a set value.

(6) The method for designing the cylinder device according to the above form (5), wherein in the cracking pressure setting process, a reference pressure receiving area that is an indication of a pressure receiving area of the piston is set, and the reference cracking pressure is set based on the reference pressure receiving area and the weight of the upper one of the two objects.

As described above, a force produced by the cylinder device is determined by the pressure receiving area and the internal pressure in the chamber. Thus, where the reference pressure receiving area is set, the reference cracking pressure can be set. That is, the method described in the present form is effective in a case where the pressure receiving area of the piston is roughly determined.

(7) The method for designing the cylinder device according to the above form (5) or (6), further comprising a design value determination process in which the porous body used for the cylinder device is determined based on the reference cracking pressure, the reference pore diameter, and a reference pressure receiving area that is an indication of a pressure receiving area of the piston, wherein a design value of the pressure receiving area of the piston and a design value of the cracking pressure which are related to the porous body are determined.

The value determined in the pore diameter determination process is only a value as the indication. Thus, in the design value determination process described in the present form, a porous body having a pore diameter close to the reference pore diameter determined in the pore diameter determination process can be actually employed for the cylinder device, for example. Also, in a case where the porous body having the reference pore diameter exists, and the porous body having the reference pore diameter is actually employed for the cylinder device, the reference pore diameter itself is determined as the design value.

Where a porous body actually employed for the cylinder device is determined, that is, where a pore diameter of the porous body actually employed for the cylinder device is determined, the design value of the cracking pressure is determined based on the above-described relationship between the cracking pressure and the pore diameter of the porous body, and the design value of the pressure receiving area of the piston is also determined based on the design value of the cracking pressure. It is noted that in the case where the porous body having the reference pore diameter is actually employed for the cylinder device as described above, the reference cracking pressure itself, as a parameter determining the reference pore diameter, is also determined as the set value.

(8) The method for designing the cylinder device according to any one of the above forms (1) through (7), further comprising an initial-compression spring constant setting process in which an initial-compression spring constant is set, wherein the initial-compression spring constant is a rate of change in the internal pressure in the chamber with respect to an amount of stroke performed by the cylinder device until the working liquid starts to flow into the multiplicity of pores of the porous body.

A force of the cylinder device for supporting the upper object is mainly dependent on the internal pressure in the chamber which is produced by the flow of the working liquid into the pores of the porous body. However, in a case where at least one of the two objects is vibrated, where the cylinder device is repeatedly contracted and expanded, and where its contraction and expansion are small, the working liquid does not frequently flow into or out of the pores of the porous body, so that the cylinder device is contracted and expanded with the change in capacity of the chamber which is mainly caused by the change in volume of the working liquid. That is, in such a case, the stroke of the cylinder device is mainly dependent on the bulk modulus of the working liquid (i.e., the inverse of the compressibility). The stroke of the cylinder device until the working liquid starts to flow into the pores of the porous body is mainly due to the compression of the working liquid, and the above-described initial-compression spring constant is considered to greatly affect a dynamic spring constant of the cylinder device. Accordingly, in the initial-compression spring constant setting process described in the present form, the above-described initial-compression spring constant is set at a value equal to a target value of the dynamic spring constant of the cylinder device.

(9) The method for designing the cylinder device according to the above form (8), wherein in the initial-compression spring constant setting process, the initial-compression spring constant is set at a value less than a spring constant that is determined according to a bulk modulus of water.

In the method described in the present form, a magnitude for setting the initial-compression spring constant is set. The spring constant determined according to the bulk modulus of water is too high as the dynamic spring constant of the cylinder device. In the method described in the present form, the initial-compression spring constant is set at a value smaller than the spring constant determined according to the bulk modulus of water. Thus, the dynamic spring constant of the cylinder device is made appropriate.

(10) The method for designing the cylinder device according to the above form (8) or (9), further comprising a working liquid amount determination process in which the working liquid is selected, a pressure receiving area of the piston is set, and the amount of the working liquid is determined based on a bulk modulus of the selected working liquid, the set pressure receiving area of the piston, and the set initial-compression spring constant and using a relationship in which the initial-compression spring constant is equal to a value obtained by dividing, by the amount of the working liquid, a product of the bulk modulus of the working liquid and a square of the pressure receiving area of the piston.

(11) The method for designing the cylinder device according to the above form (8) or (9), further comprising:

a bulk modulus determination process in which a pressure receiving area of the piston and the amount of the working liquid are set, and a bulk modulus is calculated and determined, as a designed bulk modulus, based on the set pressure receiving area of the piston, the set amount of the working liquid, and the set initial-compression spring constant and using a relationship in which the initial-compression spring constant is equal to a value obtained by dividing, by the amount of the working liquid, a product of a bulk modulus of the working liquid and a square of the pressure receiving area of the piston; and

a bulk-modulus adjustment material determination process in which a material to be contained in the chamber is determined to adjust, to the designed bulk modulus, a bulk modulus of the chamber which is an inverse of a change in capacity of the chamber with respect to a force applied to the chamber, the material having a bulk modulus which differs from that of the working liquid.

The methods described in the above-described two forms concretize a technique for achieving the set initial-compression spring constant. These two methods utilize a relationship in which the initial-compression spring constant is equal to the value obtained by dividing, by the amount of working liquid, the product of the bulk modulus of the working liquid and the square of the pressure receiving area of the piston. The former method is a technique of adjusting the amount of working liquid to set the initial-compression spring constant at a set constant, while the latter method is a technique of adjusting the bulk modulus of the chamber, i.e., changing an apparent bulk modulus of the working liquid to set the initial-compression spring constant at the set constant.

In the former method, the cylinder device containing the working liquid having the amount determined in the working liquid amount determination process can be achieved by, for example, making the cylinder device longer and/or making a dimension of the cylinder device in its radial direction longer. However, various limitations lie depending upon, e.g., a place at which the cylinder device is installed. Thus, as will be explained in detail later, a sub-housing coupled to the housing can be provided using a part of space located outside the cylinder device to achieve the cylinder device configured to contain the working liquid having the amount determined in the working liquid amount determination process.

Examples of the material described in the latter method include gas, liquid, and solid. Specifically, examples of the material include compressed air, rubber, and oil. It is noted that each of these materials has a bulk modulus lower than that of water and accordingly is preferable as a material that determines the initial-compression spring constant at a value smaller than a spring constant that is determined according to the bulk modulus of water. It is noted that the material may be directly contained in the chamber, but in the case where the material is gas or liquid, the cylinder device may be configured such that the material is hermetically contained in, e.g., a container that is disposed in the chamber.

(21) A cylinder device serving as a colloidal damper and comprising:

a housing coupled to one of two objects which move relative to each other;

a piston coupled to another of the two objects and slidable in the housing;

a porous body and working liquid contained inside a chamber defined by the housing and the piston, the porous body having a multiplicity of pores; and

a sealing member having flexibility, provided to define a sealed space in the chamber, hermetically containing the porous body and a portion of the working liquid in the sealed space in a state in which the porous body and the portion of the working liquid are mixed with each other, and being deformable to allow a change in a capacity of the sealed space,

the cylinder device being configured to support an upper one of the two objects depending upon a pressure in the sealed space which is produced by a state in which the working liquid has flowed in the multiplicity of pores of the porous body and damp relative movement between the two objects by utilizing a change in an amount of the working liquid flowing in the multiplicity of pores of the porous body, the change being caused by the relative movement between the two objects.

As explained above, the present form indicates the construction as the base of the cylinder device according to the claimable invention. That is, the cylinder device in the present form including fundamental constituent elements of the colloidal damper according to the claimable invention.

The cylinder device described in the present form is configured such that the colloidal solution is hermetically contained in the space formed by the sealing member to prevent the porous body and the working liquid from flowing out of the sealed space. That is, the porous body and the piston do not rub against each other in the cylinder device described in the present form, preventing friction in the housing. Accordingly, the cylinder device described in the present form achieves a colloidal damper having high durability.

In the cylinder device described in the present form, a remaining portion of the working liquid except the portion of the working liquid which is isolated in the sealed space by the sealing member is located inside the chamber and outside the sealed space. That is, the cylinder device described in the present form is configured such that a force to be applied to the housing and the piston is transmitted to the sealing member via outside-sealed-space working liquid that is the remaining portion of the working liquid. The portion of the working liquid (hereinafter may be referred to as “inside-sealed-space working liquid”) and the remaining portion of the working liquid (i.e., the outside-sealed-space working liquid) in the cylinder device described in the present form may be identical to each other and may be different in property from each other.

The sealing member described in the present form is for allowing a change in a volume of the colloidal solution with the flow of the working liquid into and out of the porous body while maintaining the state in which the colloidal solution is hermetically contained. The space for hermetically containing the colloidal solution may be formed by the sealing member alone or with the housing. Specifically, the configuration in which the sealing member alone forms the space for hermetically containing the colloidal solution can be achieved by making the sealing member have a shape like a container filled with the colloidal solution, for example. On the other hand, the configuration in which the sealing member cooperates with the housing to form the space for hermetically containing the colloidal solution can be achieved by fixing an outer peripheral portion of a flexible member to an inner face of the housing, for example. It is noted that the sealing member is elastically deformable to change the capacity of the sealed space and may be shaped like a plate or a bag or have a property of contraction and expansion. Also, the sealing member may be formed of any material such as rubber and metal.

(22) The cylinder device according to the above form (21), wherein the cylinder device further comprises a material contained outside the sealed space and inside the chamber, and a bulk modulus of the material differs from that of the working liquid.

(23) The cylinder device according to the above form (22), wherein the working liquid is water, and the bulk modulus of the material is less than that of water.

(24) The cylinder device according to the above form (22) or (23), wherein the material is compressed air.

In the cylinder devices described in the above-described three forms, the material can adjust the bulk modulus of the chamber. That is, as the material, a material determined in the bulk-modulus adjustment material determination process can be employed, and in this configuration, the initial-compression spring constant is made appropriate, and accordingly the dynamic spring constant is made appropriate in the cylinder devices described in the above-described three forms.

(25) The cylinder device according to any one of the above forms (22) through (24),

wherein the sealing member is a first sealing member, and

wherein the cylinder device comprises a flexible second sealing member hermtically containing the material.

In the cylinder device described in the present form, in a case where the bulk modulus adjustment material is liquid or gas, it is possible to prevent the bulk modulus adjustment material in the form of liquid or gas from being mixed with the working liquid. That is, the cylinder device described in the present form is preferable in the case where the bulk modulus adjustment material is liquid or gas.

(26) The cylinder device according to the above form (21), wherein the cylinder device further comprises a sub-housing coupled to the housing such that an inside of the sub-housing communicates with an inside of the housing to form the chamber.

In the cylinder device described in the present form, the sub-housing is configured to adjust an amount of working liquid contained in the chamber to the amount of working liquid which is determined in the above-described working liquid amount determination process. In the cylinder device described in the present form, the amount of the working liquid contained in the chamber is made larger by a capacity of the sub-housing. In the case of the cylinder device using water as the working liquid, for example, a spring constant thereof is preferably set to be smaller than the spring constant determined according to the bulk modulus of water as described above, which creates a need for increasing an amount of water as the working liquid. That is, the cylinder device in the present form is effective in particular in a case where the working liquid is liquid having a relatively large bulk modulus such as water. It is noted that in a case where there is a limit to the length of the cylinder device or where a device or the like is located around the cylinder device, the cylinder device described in the present form can be disposed as long as there is a space around the cylinder device.

(27) The cylinder device according to the above form (25), wherein a capacity of the sub-housing is equal to or greater than 45 percent and equal to or less than 100 percent of a capacity that is obtained by subtracting a volume of the porous body from a capacity of the housing.

In the cylinder device described in the present form, the size of the sub-housing is limited and determined at the capacity obtained by subtracting the volume of the porous body from the maximum capacity of the housing, that is, the size of the sub-housing is determined based on the maximum amount of the working liquid that can be contained in the housing. In the cylinder device in the present form, the initial-compression spring constant can be made about 70-50 percent of the spring constant of the cylinder device not including the sub-housing. That is, the cylinder device in the present form is also effective in particular in the case where the working liquid is liquid having a relatively large bulk modulus such as water.

(28) The cylinder device according to any one of the above forms (21) through (27), wherein the cylinder device is configured such that an amount by which the cylinder device is capable of stroking to a contracting side from a state in which the two objects are at rest is large when compared with an amount by which the cylinder device is capable of stroking to an expanding side.

In a case where the cylinder device is repeatedly expanded and contracted due to vibrations of at least one of the two objects, there may be a delay in increase of the internal pressure in the chamber in the colloidal damper near a center of a range of expansion and contraction of the cylinder device and on a contracting-side of the center. That is, in the case where the cylinder device is repeatedly expanded and contracted, there is a risk that the center of the range of expansion and contraction is located lower than the neutral position in the rest state. In the cylinder device described in the present form, however, the neutral position in the rest state is set on the expanding side, whereby a range of stroke during operation is made appropriate.

### BRIEF DESCRIPTION OF THE DRAWINGS

FIG. 1 is a front cross-sectional view illustrating a cylinder device having a simple structure and serving as a colloidal damper.

FIG. 2 is a cross-sectional view schematically illustrating a porous body illustrated in FIG. 1.

FIG. 3 is a view illustrating a relationship between a stroke of the colloidal damper illustrated in FIG. 1 and an internal pressure in a chamber.

FIG. 4 is a cross-sectional view schematically illustrating a balanced state between the internal pressure in the chamber and an internal pressure in pores of the porous body illustrated in FIG. 2.

FIG. 5 is a front elevational view illustrating a suspension device including, as one component, a suspension cylinder that is one example of a cylinder device to be designed by a designing method according to one embodiment of the claimable invention.

FIG. 6 is a view illustrating a relationship between a stroke and a cylinder force for each of cylinder devices respectively using three types of hydrophobized porous silica gels having different pore diameters.

FIG. 7 is a front cross-sectional view illustrating a cylinder device designed by a designing method according to a first embodiment of the claimable invention.

FIG. 8 is a view illustrating a relationship between a stroke and a cylinder force in a case where a cylinder device not containing a bulk modulus adjustment material illustrated in FIG. 7 is vibrated.

FIG. 9 is a view illustrating a relationship between a stroke and a cylinder force in the cylinder device in FIG. 7.

FIG. 10 is a front cross-sectional view illustrating a cylinder device designed by a method according to a second embodiment of the claimable invention.

### DESCRIPTION OF THE EMBODIMENTS

There will be explained representative embodiments of the claimable invention by reference to drawings. It is to be understood that the claimable invention are not limited to the following embodiments, and may be otherwise embodied with various changes and modifications, such as those described in the foregoing “FORMS OF THE INVENTION” which may occur to those skilled in the art.

<Concept of Method for Designing Cylinder Device>

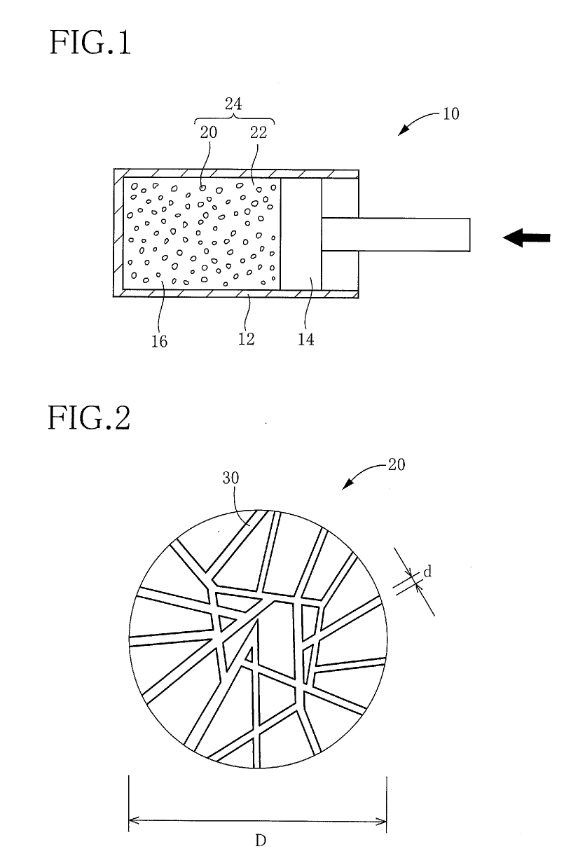

Before explaining methods for designing a cylinder device according to the present embodiments, characteristics of a colloidal damper will be explained in detail taking as an example a cylinder device 10 illustrated in FIG. 1 which has a simple structure and serves as a colloidal damper. The cylinder device 10 includes a housing 12 and a piston 14 that is slid in the housing 12. The cylinder device 10 has a chamber 16 defined by the housing 12 and the piston 14, and this chamber 16 is filled with a colloidal solution 24 consisting of porous bodies 20 and working liquid 22. FIG. 2 is a cross-sectional view schematically illustrating the porous body 20. Each of the porous bodies 20 is a round particle having an outside diameter D that is ranged from several micrometers to several tens of micrometers. Each porous body 20 has a multiplicity of pores 30 each having an inside diameter d that is ranged from several nanometers to several tens of nanometers.

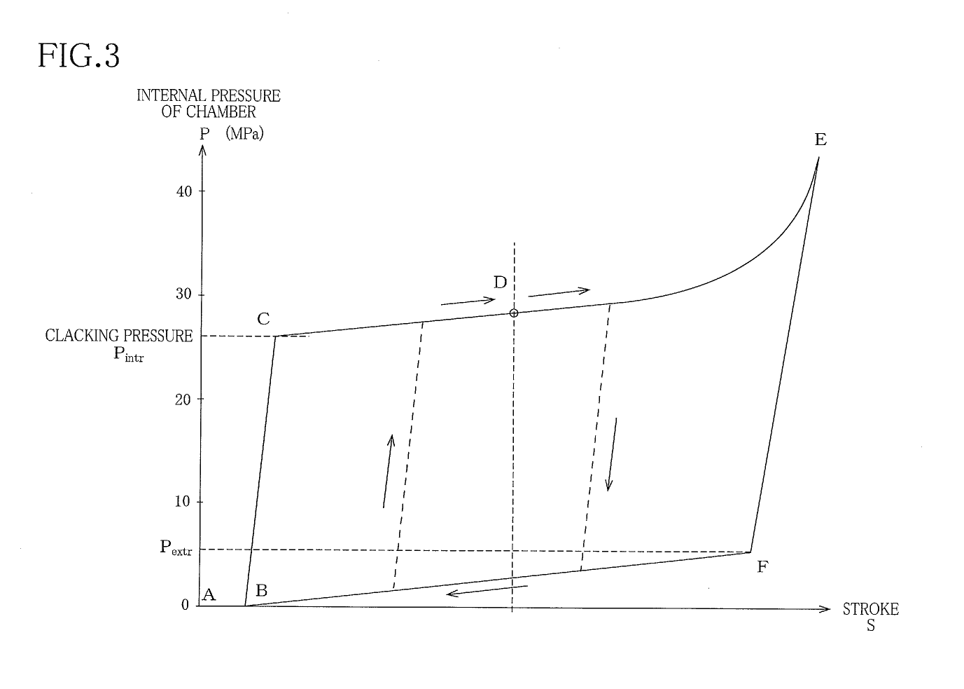

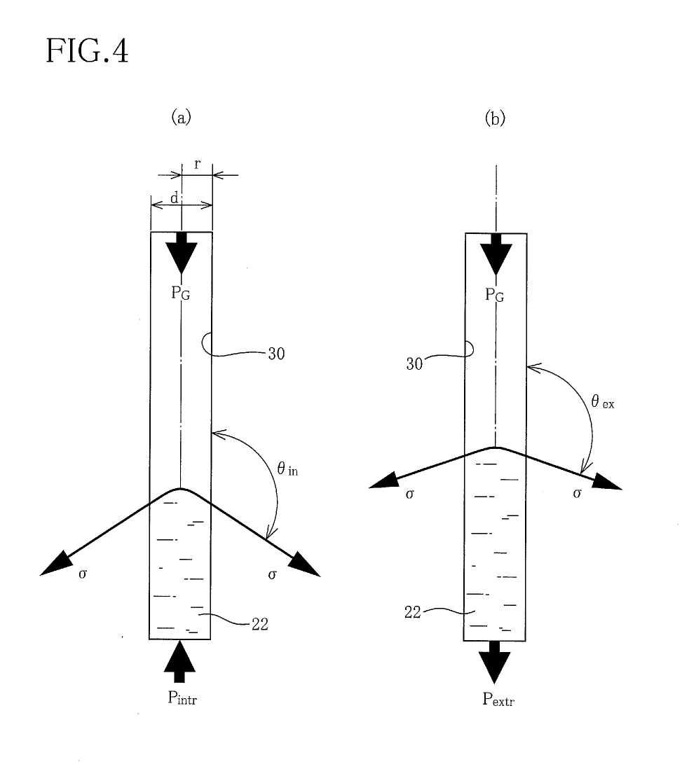

FIG. 3 illustrates a relationship between an internal pressure P in the chamber 16 and an amount of relative movement S between the housing 12 and the piston 14 (i.e., a stroke of the cylinder device 10). It is noted that an amount of change in the internal pressure P with respect to an amount of change in the stroke S, i.e., a rate of change in the internal pressure P with respect to the stroke S will be referred to as “spring constant” in the following explanation. There will be explained characteristics of point A to point F and to point B illustrated in FIG. 3 and a process for deriving an equation representative of a concept of the methods for designing the cylinder device according to the present embodiments.

A-B

A stroke from point A to point B is caused by elements such as air having entered into the chamber 16 upon, e.g., assembly of the cylinder device 10, air between a plurality of porous bodies 20, and air in a gap sealed by a seal member, that is, this stroke is a lost stroke.

ii) B-C (Calculation of Initial-compression Spring Constant)

From point B to point C, elements such as rubbers, resins, and seals of the cylinder device 10, the working liquid 22 in the chamber 16, and the entered air are compressed with a stroke of the cylinder device 10 upon its contraction, resulting in a rise of the internal pressure P in the chamber 16. It is noted that this rise is mainly caused by the compression of the working liquid 22, and accordingly a spring constant from point B to point C is calculated based on compressibility β_{f} of the working liquid 22. This compressibility β_{f} of the working liquid 22 can be expressed as follows:

β_{f}=(dV_{f}/Pᵢₙₜᵣ)·(1/V_{f}) (1)

where V_{f} is an amount of working liquid, dV_{f} is a change in volume of the working liquid 22, and Pᵢₙₜᵣ is, as will be explained in detail later, an internal pressure in the chamber 16 at a timing when the working liquid 22 flows into or penetrates the porous bodies 20. Where Eq. (1) is transformed to represent the change in volumed V_{f} of the working liquid 22, the following equation is obtained.

dV_{f}=β_{f}Pᵢₙₜᵣ·V_{f} (2)

An initial-compression spring constant K₁ as the spring constant from point B to point C can be expressed as follows:

K₁=Pᵢₙₜᵣ·Ap/(dV_{f}/Ap) (3)

where Ap is a pressure receiving area of the piston 14. By substituting Eq. (2) into Eq. (3), the following equation is obtained.

K₁=Pᵢₙₜᵣ·Ap²/(β_{f}·Pᵢₙₜᵣ·V_{f})=1/βf·(Ap²/V_{f}) (4)

where 1/β is the inverse of the compressibility β of the working liquid 22 and is a bulk modulus G₁ of the working liquid 22. That is, as expressed in Eq. (5), the initial-compression spring constant K₁ is equal to a value obtained by deviding, by the amount of working liquid V_{f}, the product of the bulk modulus G₁ of the working liquid 22 and the square of the pressure receiving area Ap of the piston.

K₁=G₁·(Ap²/V_{f}) (5)

iii) Point C (Cracking Pressure)

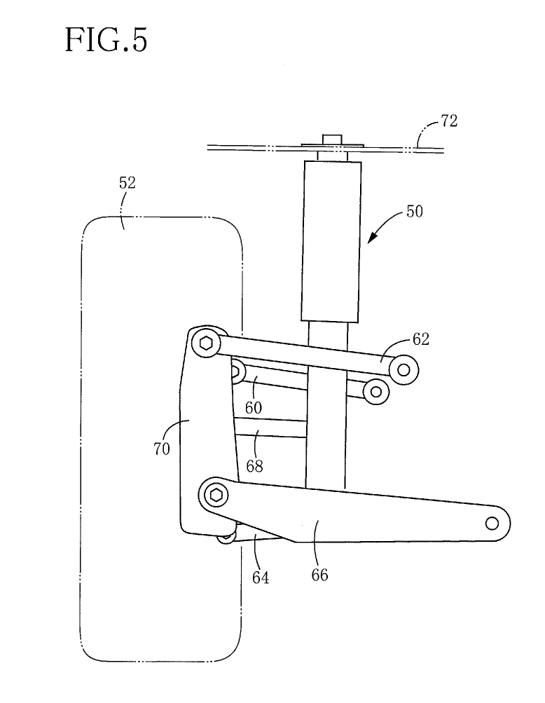

Point C is a point at which the working liquid 22 starts to flow into the pores 30 of the porous bodies 20. In the following explanation, the internal pressure in the chamber 16 at the timing when the working liquid 22 starts to flow into the pores 30 will be referred to as “cracking pressure Pᵢₙₜᵣ”. As illustrated in a conceptual view in FIG. 4(a), this cracking pressure Pᵢₙₜ is obtained according to an equation expressing a balance between the internal pressure in the chamber 16 and an internal pressure in the pores 30 (i.e., a capillary pressure or a Laplace pressure), and expressed as follows:

Pᵢₙₜᵣ=−2·σ·cos θᵢₙ/r+P_{G} (6)

where σ is a surface tension of the working liquid 22, θᵢₙ is a contact angle of the working liquid 22 at its inflow, r is a radius of the pore 30, and P_{G} is a pressure generated by compression of the air inside the pore 30. It is noted that since a magnitude of the pressure P_{G} is very small when compared with a magnitude of a component depending upon the surface tension of the working liquid 22, the pressure P_{G} can be neglected. That is, a dominant parameter upon determination of the cracking pressure Pᵢₙₜᵣ is the radius r of the pore 30 (i.e., a diameter of each pore or a pore diameter d). In a case where the cylinder device 10 is configured so as to support an object located on an upper side of the cylinder device 10, by the internal pressure P in the chamber 16 which is produced by the state in which the pores 30 are filled with the working liquid 22, the cracking pressure Pᵢₙₜᵣ and the pressure receiving area Ap of the piston 14 determine an approximate weight that is supportable by the cylinder device 10.

iv) Point C to Vicinity of Point D (Spring Characteristics Depending upon Colloidal Solution)

When the internal pressure in the chamber 16 has reached the cracking pressure, and the cylinder device 10 is stroked, the working liquid 22 is further compressed, and thereby a hydraulic pressure rises, resulting in increase of an amount of the working liquid 22 flowing into the pores 30 of the porous bodies 20. The flow of the working liquid 22 into the porous bodies 20 reduces a volume of the colloidal solution 24, so that the cylinder device 10 is stroked so as to be contracted. That is, it is possible to consider that, in a section from point C to the vicinity of point D, the cylinder device 10 has spring characteristics in which a spring having characteristics depending upon the bulk modulus G₁ of the working liquid 22 and a spring having characteristics that are provided by the flow of the working liquid 22 into the pores 30 of the porous bodies 20 are arranged in series. That is, assuming that a spring constant of the spring having the characteristics provided by the flow of the working liquid 22 into the pores 30 of the porous bodies 20 is a spring constant K₂, a spring constant Kₐₗₗ in the section from point C to the vicinity of point D can be expressed as follows:

Kₐₗₗ=1/(1/K₁1/K₂) (7)

In the section from point C to the vicinity of point D, the spring characteristics that are provided by the flow of the working liquid 22 into the pores 30 of the porous bodies 20 (hereinafter may be referred to as “spring characteristics due to the colloidal solution”) is main characteristics. Thus, the spring constant K₂ as the spring characteristics due to the colloidal solution (hereinafter may be referred to as “the spring constant K₂ due to the colloidal solution”) is calculated as described below.

In the section from point C to the vicinity of point D, the internal pressure in the chamber 16 increases with the stroke of the cylinder device 10 upon its contraction, thereby increasing potential energy E of the cylinder device 10. Eq. (8) represents a relationship between the potential energy E and a change dΩ in area in which the working liquid 22 contacts the porous body 20 inside the pores 30. The spring constant K₂ due to colloidal solution is derived using this equation.

E=−σ·dΩ·cos θᵢₙ (8)

The change dΩ in contact area can be expressed as follows:

dΩ=2·dV/r (9)

where dV is an amount of the working liquid 22 flowing into the pores by the stroke of the cylinder device 10. Also, the inflow amount dV of the working liquid 22 can be expressed as follows:

dV=Ap·Xp (10)

where Xp is an amount of displacement of the piston 14 with respect to the housing 12 from point C. By substituting Eqs. (9) and (10) into Eq. (8), the following equation can be obtained:

E=−2·σ·cos θᵢₙ·Ap·Xp/r (11)

In a case where the cylinder device 10 is considered to serve as a spring having the spring constant K₂, potential energy of the cylinder device 10 can be expressed as follows:

E=1/2·K₂·Xp² (12)

From Eqs. (11) and (12), the following equation can be obtained.

−2·σ·cos θᵢₙ·Ap·Xp/r=1/2·K₂·Xp² (13)

By transforming Eq. (13) for the spring constant K₂ due to the colloidal solution, the following equation is obtained.

K₂=−4·σ·Ap·cos θᵢₙ/(r·Xp) (14)

It is noted that, assuming that Xpr is an amount of displacement (i.e., an effective stroke) represented by a linear domain from point C, the effective stroke Xpr can be expressed as follows:

Xpr=Vₚₘ·δᵥₚρ/Ap (15)

where Vₚₘ is a volume of the porous bodies 20, δᵥₚ is a pore bulk ratio of the porous bodies 20, μ is a density of the porous body, and Ap is the pressure receiving area of the piston 14. By substituting Eq. (15) into Eq. (14), Eq. (16) is obtained for calculating a spring constant of the colloidal solution within a range of the effective stroke.

K₂=−4·σ·Ap²·cos θᵢₙ/(r·Vₚₘ·δᵥₚ·ρ) (16)

Assuming that elements in Eq. (16) which are determined only by intrinsic values of the porous bodies 20 and the working liquid 22 are defined as G₂, Eq. (16) can be simplified as follows:

K₂=G₂·(Ap²/Vₚₘ) (17)

G₂=−4·σ·cos θᵢₙ/(r·δᵥₚ·ρ) (18)

That is, G₂ can be considered to correspond to a bulk modulus G₂ of the colloidal solution.

v) Vicinity of Point D to Point E (Nonlinear Domain)

In a section from the vicinity of point D to point E (i.e., a nonlinear domain), when the working liquid 22 has flowed into the porous bodies 20 by an amount that is close to an amount corresponding to the volume of the porous bodies 20, a hydraulic pressure of the working liquid 22 starts to rise considerably. It is noted that the reason why this domain is the nonlinear domain is not clear, but the reason is considered to include: a pore bulk ratio with respect to the weight of the porous body 20; a gradient of the pore diameter; and variations of the hydrophobizing processing in a case where the porous bodies 20 are hydrophobized, for example.

vi) Point E-Point F-Point B (Characteristics in Return Trip)

At point E, the stroke of the cylinder device 10 is switched from a contracting side to an expanding side. At point F, the working liquid 22 starts to flow out of or exude from the pores 30 of the porous bodies 20. As illustrated in the conceptual view in FIG. 4(b), a pressure in the chamber at point F is obtained according to Eq. (19) expressing a balance between the internal pressure in the chamber 16 and the internal pressure in the pores 30.

Pₑₓₜᵣ=−2·σ·cos θₑₓ/r+P_{G} (19)

where θₑₓ is a contact angle of the working liquid 22 when the working liquid 22 flows out. Since the contact angle θₑₓ at the outflow is closer to 90 degrees than the contact angle θᵢₙ at the inflow, cos θₑₓ is small, whereby the working liquid 22 is to flow out of the pores 30 by a small force. Thus, in a section from point E to point F, the compression is released for the entered air, the working liquid 22 in the chamber 16, and the elements such as the rubbers, resins, and seals of the cylinder device 10, resulting in sudden reduction of the internal pressure in the chamber 16. This reduction of the internal pressure in the chamber 16 causes the working liquid 22 to flow out of the pores 30 of the porous bodies 20 in a section from point F to point B, resulting in increase of the volume of the colloidal solution 24, so that the cylinder device 10 is stroked so as to expand.

vii) Damping Characteristics

Broken lines in FIG. 3 indicate a relationship between the stroke S of the cylinder device 10 and a change in the internal pressure in the chamber 16 in one cycle of operation of the cylinder device 10 from a neutral position that is a position of the cylinder device 10 in a state in which two objects which move relative to each other are at rest. As explained above, the internal pressure in the chamber 16 at the inflow of the working liquid (i.e., at contraction) and the internal pressure in the chamber 16 at the outflow of the working liquid (i.e., at expansion) differ from each other, so that a relationship between a change of the stroke S of the cylinder device 10 and a change of the internal pressure in the chamber 16 exhibits hysteresis as illustrated in FIG. 3. An area enclosed by two-dot chain lines in FIG. 3 corresponds to energy dissipated in one cycle of operation. It is noted that the above-described broken lines indicate a static characteristic, but a dynamic characteristic indicates an oval shape, whereby a damping efficiency is lower in the dynamic characteristic than in the static characteristic.

### First Embodiment

A method for designing a cylinder device according to the first embodiment will be explained in detail. As illustrated in FIG. 5, a cylinder device 50 to be designed according to the present method is one component of each of suspension devices for a vehicle, in the form of a suspension cylinder for suspending a body of the vehicle. Specifically, these suspension devices are provided respectively for wheels 52, and each suspension device is of an independent type and a multilink type. Each of the suspension devices includes a first upper arm 60, a second upper arm 62, a first lower arm 64, a second lower arm 66, and a toe control arm 68 each as a suspension arm. One end portion of each of the five arms 60, 62, 64, 66, 68 is pivotably connected to the vehicle body while the other end portion is pivotably connected to an axle carrier 70 as a wheel holder that rotatably holds a corresponding one of the wheels 52. These five arms 60, 62, 64, 66, 68 allow the axle carrier 70 to move vertically relative to the vehicle body along a constant locus. The cylinder device 50 is provided between the second lower arm 66 and a mount portion 72 provided on a tire housing as a portion of the vehicle body.

The cylinder device 50 uses a colloidal solution consisting of a hydrophobized porous silica gel and water as working liquid. That is, the cylinder device 50 is configured such that each of particles of the hydrophobized porous silica gel serves as the porous body.

<Determination of Cracking Pressure, Pore Diameter, and Pressure Receiving Area>

i) Cracking Pressure Setting Process

The cylinder device 50 is first designed such that an internal pressure in a chamber in a state in which water has flowed in pores of the particles of the hydrophobized porous silica gel bears a divided load Wcf of the vehicle body (=6000 N). A force produced by the cylinder device 50 is determined by the product of an internal pressure P in the chamber and a pressure receiving area Ap of a piston. Thus, in consideration of a pressure receiving area of a cylinder device for a common vehicle, a reference pressure receiving area Ap′ (=2.01 cm₂) was set as an indication of a pressure receiving area of the piston. Based on the reference pressure receiving area Ap′, Wcf/Ap′ (=29.9 MPa) is required for the internal pressure P in the chamber at the neutral position. Also, taking it consideration that a spring constant Kₐₗₗ in a range of relative movement between the vehicle body and the wheel, i.e., in the section from point C to the vicinity of point D in FIG. 3 was determined at a target value of a spring constant of a common vehicle, a reference cracking pressure Pᵢₙₜᵣ′ (=25 MPa) was set as an indication of the cracking pressure.

ii) Pore Diameter Determination Process

As described above, the cracking pressure Pᵢₙₜ is expressed in Eq. (6) according to the equation expressing the balance between the internal pressure in the chamber 16 and the internal pressure in the pores 30 (i.e., the capillary pressure or the Laplace pressure).

Pᵢₙₜᵣ==2·σ·cos θᵢₙ/r+P_{G} (6)

It is noted that since the magnitude of the pressure P_{G} is very small when compared with the magnitude of the component depending upon the surface tension of the working liquid 22, the pressure P_{G} can be neglected. Also, since each of σ and θᵢₙ is an intrinsic value of water as the working liquid, the cracking pressure Pᵢₙₜᵣ and the radius r of the pore of the porous body have a predetermined relationship. That is, based on the surface tension σ (=72.8 mN/m) of water, the contact angle θᵢₙ (=128.5 degree) of the surface tension at the inflow of water, and the reference cracking pressure Pᵢₙₜᵣ′ described above, a reference pore radius r′ (=−2·σ·cos θᵢₙ/Pᵢₙₜᵣ′=3.62 nm) as an indication of a pore diameter of the hydrophobized porous silica gel as the porous body is determined according to Eq. (6).

iii) Design Value Determination Process

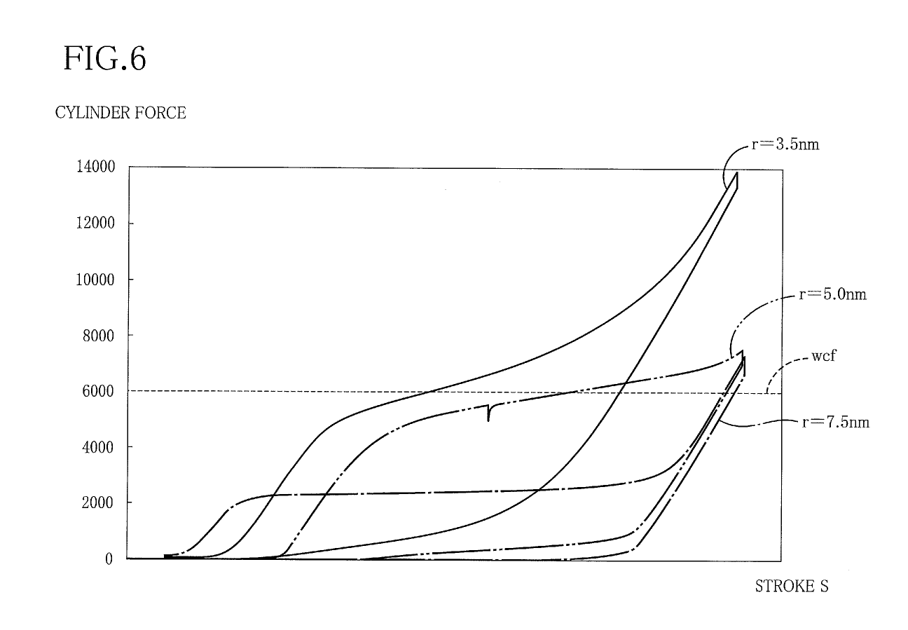

Next, three types of hydrophobized porous silica gels having different pore diameters were prepared. Specifically, these hydrophobized porous silica gels have pore radiuses of 3.5 nm, 5.0 nm, and 7.5 nm. For each of the hydrophobized porous silica gels, FIG. 6 illustrates a relationship between a stroke amount and a cylinder force which were actually measured. It is noted that a piston of a cylinder device used for the actual measurement has the above-described reference pressure receiving area Ap′. FIG. 6 also shows that the hydrophobized porous silica gel having the pore radius of 3.5 nm that is close to the reference pore radius r′ is the most appropriate for bearing the divided load Wcf (=6000 N). Thus, a design value of the pore diameter of the porous silica gel is determined at 7 nm (that is, the radius is 3.5 nm). It is noted that an actual measurement value of a cracking pressure of the cylinder device using the hydrophobized porous silica gel having the pore radius of 3.5 nm was 25.55 MPa (which is an average value in a case where N is 9). That is, since the actual measurement value is generally equal to the reference cracking pressure Pᵢₙₜᵣ′, the reference pressure receiving area Ap′ used for the calculation of the reference cracking pressure Pᵢₙₜᵣ′ is determined as a design value of the pressure receiving area Ap of the piston.

<Determination of Amount of Hydrophobized Porous Silica Gel as Indication>

In the present designing method, throughout a range in which the cylinder device 50 is stroked to the contracting side, i.e., within a period from a full rebound to a full bound, the cylinder device 50 is designed so as to stroke within a range in which the internal pressure P in the chamber is proportional to an amount of water flowing into the pores of the hydrophobized porous silica gel. To design the cylinder device 50 having such a structure, an amount (volume) of the hydrophobized porous silica gel and an amount (volume) of water are set. First, in a case where the cylinder device 50 is designed to be capable of stroking from the neutral position in a normal state (e.g., a state in which no persons or no loads are on the vehicle that is at rest on a horizontal surface), by a stroke amount S_{b} 70 mm) in a bound direction and a stroke amount Sᵣ (=70 mm) in a recound direction, a change in capacity ΔV of the chamber from the full rebound to the full bound is obtained by the following equation:

ΔV=Ap·(S_{b}+Sᵣ)

Next, the present cylinder device 50 is designed such that water having an amount equal to the change in capacity AV can flow into the hydrophobized porous silica gel. That is, where a ratio of a maximum amount of water receivable by the hydrophobized porous silica gel, to a volume of the hydrophobized porous silica gel is defined as η, a minimum amount (volume) V_{Smin} of the hydrophobized porous silica gel required is determined by the following equation:

V_{Smin}=ΔV/η

It is noted that, upon the hydrophobizing processing, a portion of the hydrophobized porous silica gel may remain as a silica gel having water absorbency without being hydrophobized. For example, where a ratio of an amount of hydrophobized silica gel except an amount of silica gel not hydrophobized, to a total amount of silica gel subjected to the hydrophobizing processing is defined as a hydrophobized ratio α, an amount (volume) V_{S}′ of hydrophobized porous silica gel as an indication was determined in the following equation to deal with, e.g., variation of the hydrophobized ratio:

V_{S}′=V_{Smin}/α

<Determination of Initial-compression Spring Constant and Designed Bulk Modulus>

i) Initial-Compression Spring Constant Setting Process

In the present designing method, the initial-compression spring constant K₁ as the spring constant from point B to point C illustrated in FIG. 3 is set. As will be explained in detail later, this initial-compression spring constant K₁ has a large effect on dynamic characteristics of the cylinder device 50 and accordingly needs to be set. In the present designing method, the initial-compression spring constant K₁ was set at a value that is smaller than a spring constant that is dependent upon the bulk modulus Gw of water (=1/βw, βw: the compressibility of water), specifically, at a value of about 60 percent of the spring constant that is dependent upon the bulk modulus Gw of water (=1/βw, βw: the compressibility of water).

ii) Bulk Modulus Determination Process

As described above, the initial-compression spring constant K₁ is expressed in Eq. (5).

K₁=G₁·(Ap²/V_{f}) (5)

The amount of working liquid is equal to a capacity obtained by subtracting the amount of the hydrophobized porous silica gel V_{S}′ set above from a set value V_{H} of a capacity of the housing of the cylinder device. Based on an amount of working liquid V_{f}′ (=V_{H}−V_{S}′) as an indication of the amount of working liquid and the above-determined designed pressure receiving area Ap (=2.01 cm₂) of the piston, a designed bulk modulus G₁ as a design value of a bulk modulus of the chamber is determined according to Eq. (5). That is, in the present designing method, the designed bulk modulus G₁ is set at a value of about 60 percent of the bulk modulus Gw of water such that the initial-compression spring constant K₁ becomes a value of about 60 percent of the spring constant that is dependent upon the bulk modulus Gw of water (=1/βw, βw: the compressibility of water).

ii) Bulk-modulus Adjustment Material Determination Process

To obtain the above-described designed bulk modulus G₁ (=0.6·Gw), in the present designing method, the cylinder device 50 is designed such that a material for lowering a elastic modulus of water as the working liquid is contained in the chamber. Specifically, as will be explained in detail later, compressed air is contained in a sealed container, and the container hermetically containing the compressed air is disposed in the chamber to lower the elastic modulus of water. It is noted that an initial pressure of the compressed air in the sealed container is adjusted such that the bulk modulus of the chamber becomes the above-described designed bulk modulus G₁.

<Determination of Amount of Hydrophobized Porous Silica Gel and Spring Constant of Colloidal Solution>

i) Colloidal-solution Spring-constant Determination Process

Next, the spring constant K₂ of the colloidal solution is determined according to Eq. (7).

Kₐₗₗ=1/(1/K₁+1/K₂) (7)

The spring constant Kₐₗₗ in the section from point C to the vicinity of point D in FIG. 3 was set at a spring constant Ktc (=36010 N/m) of a suspension spring for a common vehicle. The spring constant K₂ of the colloidal solution was then determined according to Eq. (7) based on the spring constant Ktc and the initial-compression spring constant K₁ determined above.

ii) Hydrophobized-porous-silica-gel Amount Determination Process

As described above, the spring constant K₂ of the colloidal solution is expressed as follows:

K₂=G₂·(Ap²/Vₚₘ) (17)

where G₂ is expressed in the following Eq. (18) and determined only by intrinsic values of the hydrophobized porous silica gel as the porous body and water as the working liquid.

G₂=−4·σ·cos θⁱⁿ/(r·δᵥₚ·ρ) (18)

That is, the amount of the hydrophobized porous silica gel V_{S} was determined according to Eq. (17) based on the bulk modulus of the colloidal solution, the designed pressure receiving area Ap (=2.01 cm₂) of the piston determined above, and the determined spring constant K₂ of the colloidal solution.

<Construction of Designed Cylinder Device>

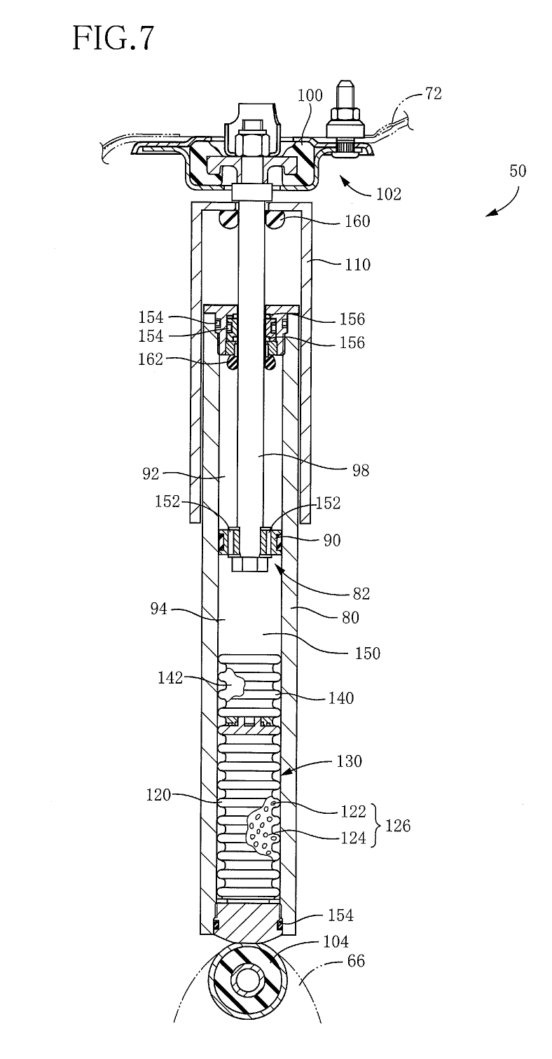

FIG. 7 illustrates a cylinder device 50 constructed according to the design values determined according to the above-described method for designing the cylinder device. FIG. 7 is a front cross-sectional view of the cylinder device 50. There will be next explained a detailed construction of the cylinder device 50 with reference to FIG. 7.

The cylinder device 50 includes: a housing 80 having generally a cylindrical shape; and a piston 82 provided slidably relative to the housing 80. The piston 82 includes a piston body 90 that separates the inside of the housing 80 into an upper chamber 92 and a lower chamber 94 located on opposite sides of the piston body 90. The piston 82 further includes a piston rod 98 whose lower end portion is connected to the piston body 90, and the piston rod 98 projects from a cap portion that is provided on an upper end portion of the housing 80. An upper end portion of the piston rod 98 is connected to a lower face of the mount portion 72 via an upper support 102 that includes a vibration-damping rubber 100. A lower end portion of the housing 80 is connected to the second lower arm 66 via a bushing 104.

That is, the housing 80, and the piston rod 98 and the piston body 90 coupled thereto are movable relative to each other in their axial direction with movement of the vehicle body (i.e., the mount portion 72) and the wheel 52 (i.e., the axle carrier 70) toward and away from each other. In other words, the cylinder device 50 can be contracted and expanded with the movement of the vehicle body and the wheels 52 toward and away from each other.

It is noted that the cylinder device 50 includes a cover tube 110 that covers the piston rod 98 and an upper portion of the housing 80 to prevent ingress of dust, mud, etc., from outside.

A bellows 120 is fixed to an inner side of a lower end portion of the housing 80 so as to be contained in the lower chamber 94. The bellows 120 is hermetically filled with a colloidal solution 126, and this colloidal solution 126 is composed of a hydrophobized porous silica gel 122 and water 124. It is noted that the bellows 120 is designed to be expanded and contracted in an up and down direction in the state in which the bellows 120 is fixed to the housing 80. Accordingly, the bellows 120 is formed as a container that defines a sealed space only by itself and serves as a first sealing member configured to hermetically contain the colloidal solution 126 in the sealed space. The cylinder device 50 includes a colloidal-solution sealing body 130 including the bellows 120 and the colloidal solution 126.

Another bellows 140 is fixed to the colloidal-solution sealing body 130. This bellows 140 hermetically contains compressed air 142 as the bulk modulus adjustment material determined according to the designing method. That is, the bellows 140 serves as a second sealing member.

It is noted that the lower chamber 94 is filled with water 150 in a state in which the colloidal-solution sealing body 130 and the bulk modulus adjustment material are contained in the lower chamber 94. The upper chamber 92 is also filled with the water 150. A plurality of communication passages 152 are formed through the piston body 90 in its axial direction to establish communication between the upper chamber 92 and the lower chamber 94. That is, when capacities of the upper chamber 92 and the lower chamber 94 change with the sliding movement of the piston 82 with respect to the housing 80, the communication passages 152 allow the water 150 to flow between the upper chamber 92 and the lower chamber 94. It is noted that since a pressure in the housing 80 becomes high, a plurality of high pressure seals 154 are provided on the cap portion of the upper end portion of the housing 80 and a cap portion of a lower end portion of the housing 80 to prevent leakage of the water 150. In particular, two seals 156 contacting a sliding surface of the piston rod 98 are provided on the cap portion of the upper end portion in which the piston rod 98 is slid. Between the two seals 156 is provided grease for enhancing sealing performance.

The cylinder device 50 includes a mechanism, namely, a bound stopper and a rebound stopper, for limiting the movement of the vehicle body and the wheel 52 toward and away from each other. Specifically, the bound stopper includes an annular cushion rubber 160 that is bonded to an inner face of an upper end of the cover tube 110 such that the upper end portion of the housing 80 is brought into contact with the cover tube 110 via the cushion rubber 160. The rebound stopper includes an annular cushion rubber 162 that is bonded to a lower face of the cap portion of the upper end portion of the housing 80 such that an upper face of the piston body 90 and the cap portion of the upper end portion of the housing 80 are brought into contact with each other via the cushion rubber 162.

It is noted that, while the colloidal solution 126 is hermetically contained in the bellows 120 in the cylinder device 50 as described above, a force applied from outside is transmitted to the colloidal-solution sealing body 130 via the water 150. That is, a hydraulic pressure of the water 150 is risen by the force applied from outside, so that a hydraulic pressure of the water 124 contained in the bellows 120 also rises. When the hydraulic pressure of the water 124 has risen to a certain pressure, the water 124 flows into the pores of the hydrophobized porous silica gel 122 against the surface tension. With this flow, the bellows 120 contracts, and a volume of the colloidal-solution sealing body 130 decreases. When the application of the force to the water 124 has ceased, the hydraulic pressure of the water 124 lowers, so that the water 124 flows out of the pores of the hydrophobized porous silica gel 122. With this flow, the bellows 120 expands, and the volume of the colloidal-solution sealing body 130 increases.

<Characteristics of Present Cylinder Device>

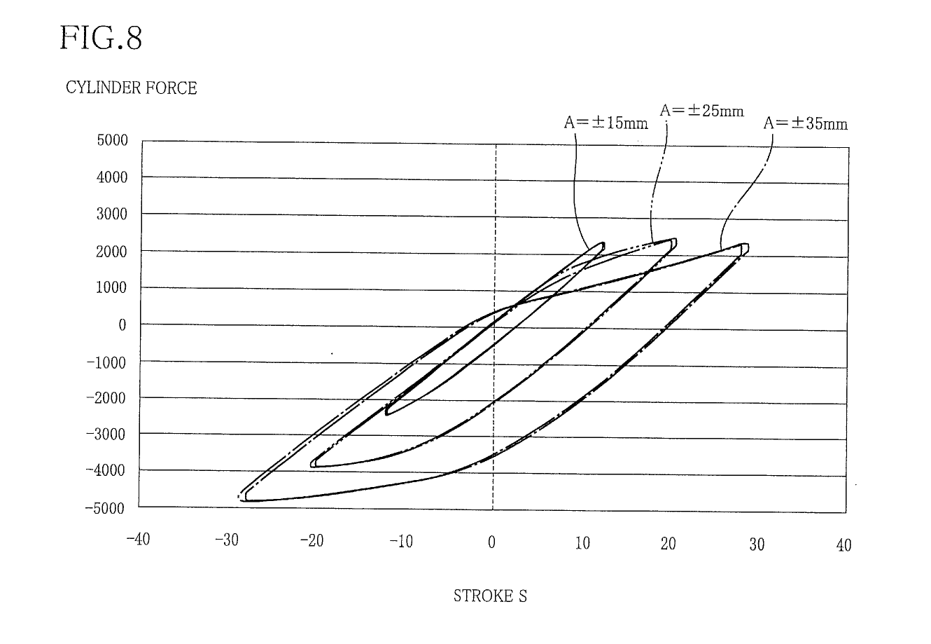

In the present cylinder device 50, the initial-compression spring constant K₁ is made appropriate according to the above-described designing method. FIG. 8 illustrates a relationship between a stroke amount and a cylinder force in a case of a cylinder device not containing the bulk modulus adjustment material, i.e., in a case where a cylinder device whose initial-compression spring constant depends upon the bulk modulus Gw of water is vibrated. The cylinder device is vibrated under the condition that a vibration amplitude A is ±15 mm, ±25 mm, and ±35 mm, and a frequency is 0.53 Hz. As seen from FIG. 8, the smaller the amplitude, the smaller amount of water flows into or out of the hydrophobized porous silica gel, causing only a stroke depending upon a change in volume of water as the working liquid. In particular, in the case where the vibration amplitude is ±15 mm, the dynamic spring constant is approximately equal to a spring constant that is dependent upon the bulk modulus Gw of water as the initial-compression spring constant. That is, in a case where a small oscillation is occuring in the amplitude in the cylinder device serving as the colloidal damper, the dynamic spring constant is greately affected by the initial-compression spring constant. In contrast, the present cylinder device 50 contains the bulk modulus adjustment material that makes the initial-compression spring constant K₁ smaller than the spring constant that is dependent upon the bulk modulus of water, resulting in reduction of deterioration of the vibration damping performance in the case where a small oscillation is occuring in the amplitude.

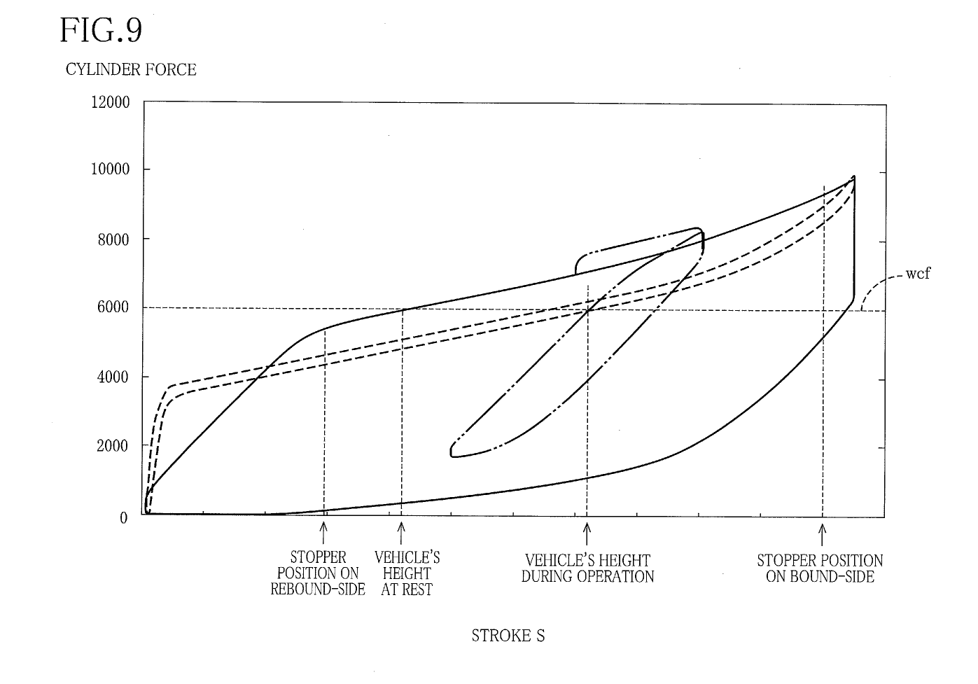

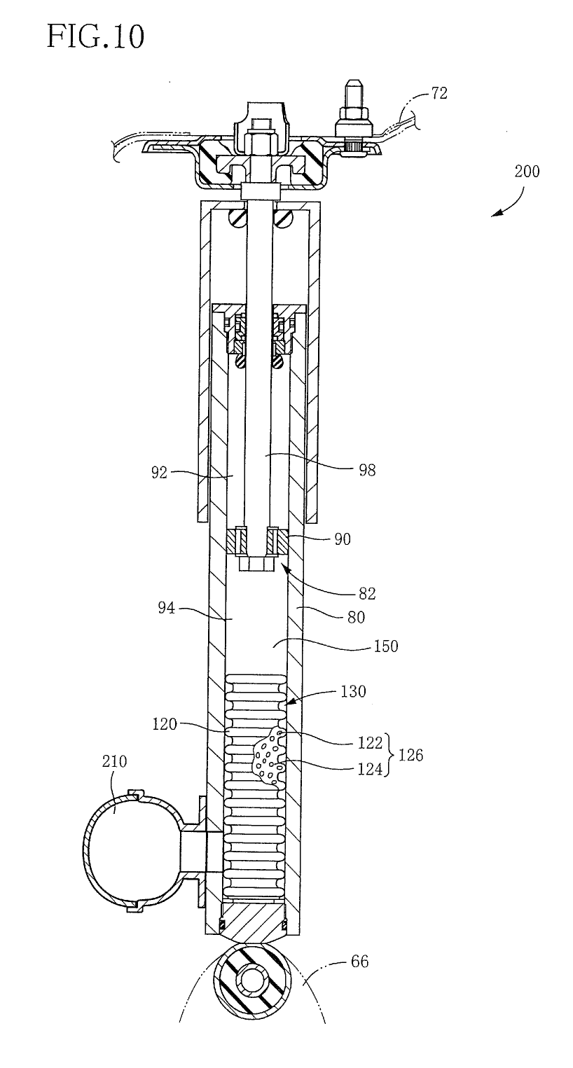

The solid line in FIG. 9 indicates a relationship between a stroke amount and a cylinder force in the present cylinder device 50. An amount of the maximum possible bound stroke from a rest state of the vehicle is made large when compared with an amount of the maximum possible rebound stroke in the present cylinder device. In other words, a position at which a cylinder force equal in magnitude to the divided load Wcf is produced is located on a rebound-side of a center of a range of the maximum possible stroke. That is, a height of the vehicle being in the rest state is set to be relatively high. Specifically, a top of the housing 80 is closed in a state in which a set pressure is applied to the piston 82, whereby an initial pressure is applied to the inside of the housing 80. As a result, the cylinder force is balanced with the divided load Wcf on the rebound-side of the center of the range of the maximum possible stroke.

The two-dot chain lines indicate a change of the cylinder force in a case where a stroke is started from the rest state to a bound side, and then two cycles are elapsed in the present cylinder device 50. As seen from the figure, a stroke to the bound side at the first cycle is along a static characteristic indicated by the solid lines, while there is a delay in increase of the cylinder force in the stroke to the bound side at the second cycle. Thus, in a case where the vehicle body and the wheel 52 are continued to be moved relative to each other, the vehicle's height is kept lower than that in the rest state. Since the vehicle's height in the rest state is set to be relatively high as described above in the present cylinder device 50, amounts of the maximum possible strokes to both of the bound side and the rebound side are made appropriate by a lowered vehicle's height during driving.

### Second Embodiment

There will be next explained a method for designing a cylinder device according to a second embodiment. The method for designing the cylinder device according to the second embodiment is different from the designing method according to the first embodiment in a process for achieving the initial-compression spring constant K₁ set in the initial-compression spring constant setting process. Thus, only the process will be explained for the designing method according to the second embodiment, and thereafter a cylinder device 200 designed by the designing method according to the second embodiment will be explained.

<Working Liquid Amount Determination Process>

As described above, the initial-compression spring constant K₁ is expressed in Eq. (5).

K₁=G₁·(Ap²/V_{f}) (5)

Working liquid used in the present cylinder device 200 is water as in the cylinder device 50 according to the first embodiment. Thus, the bulk modulus G₁ of the chamber is considered to be equal to the bulk modulus Gw of water. The amount of working liquid V_{f}, i.e., a total amount of water in the chamber was determined according to Eq. (5) based on the bulk modulus Gw of water, the above-determined designed pressure receiving area Ap of the piston, and an initial-compression spring constant K₁ set at a value that is about 60 percent of the spring constant that is dependent upon the bulk modulus Gw of water.

<Construction of Designed Cylinder Device>

FIG. 10 is a front cross-sectional view illustrating the cylinder device 200 designed based on design values determined by the method for designing the cylinder device according to the second embodiment. It is noted that the same components as used in the cylinder device 50 according to the first embodiment are used in the cylinder device 200, and an explanation thereof is dispensed with.

The present cylinder device 200 has generally the same construction as the cylinder device 50 according to the first embodiment, but the compressed air 142 as the bulk modulus adjustment material contained in the cylinder device according to the first embodiment is not contained in the chamber. The cylinder device 200 according to the present embodiment includes a sub-housing 210 that is coupled to a lower end of the housing 80. An inside of the sub-housing 210 communicates with the lower chamber 94 of the housing 80. The sub-housing 210 is also filled with the water 150 as the working liquid. A capacity of the sub-housing 210 is determined based on the amount of working liquid V_{f} determined according to the above-described designing method. That is, the capacity of the sub-housing 210 is determined such that the sub-housing 210 can contain water of an amount that is obtained by subtracting an amount of water contained in the housing 80 and an amount of water contained in the colloidal-solution sealing body 130 from the amount of working liquid V_{f}.

In the cylinder device 200 according to the present embodiment, as in the cylinder device 50 according to the first embodiment, the initial-compression spring constant K₁ is made smaller than the spring constant that is dependent upon the bulk modulus of water, resulting in reduction of deterioration of the vibration damping performance in the case where a small oscillation is occuring in the amplitude.

### EXPLANATION OF REFERENCE NUMERALS

10: Cylinder Device, 12: Housing, 14: Piston, 16: Chamber, 20: Porous Body, 22: Working Liquid, 30: Pore, 50: Cylinder Device (Suspension Cylinder), 52: Wheel, 70: Axle Carrier (Wheel Holder), 72: Mount Portion (Vehicle Body), 80: Housing, 82: Piston, 92: Upper Chamber, 94: Lower Chamber (Chamber), 120: Bellows (First Sealing Member), 122: Hydrophobized Porous Silica Gel (Porous Body), 124: Water (Working Liquid), 140: Bellows (Second Sealing Member), 142: Compressed Air (Bulk Modulus Adjustment Material), 150: Water (Working Liquid), 200: Cylinder Device, 210: Sub-Housing

r: Pore Radius, r′: Reference Pore Radius, S: Stroke, P: Internal Pressure in Chamber, Pᵢₙₜᵣ; Cracking Pressure at Inflow, Pᵢₙₜᵣ′: Reference Cracking Pressure, Pₑₓₜᵣ: Cracking Pressure at Outflow, V_{f}: Amount of Working Liquid, K₁: Initial-Compression Spring Constant, G₁: Bulk Modulus of Working Liquid, Gw: Bulk Modulus of Water, Ap: Pressure Receiving Area of Piston, Ap′: Reference Pressure Receiving Area, σ: Surface Tension of Working Liquid, θᵢₙ: Contact Angle of Working Liquid at its Inflow, K₂: Spring Constant of Colloidal Solution, G₂: Bulk Modulus of Colloidal Solution, θₑₓ: Contact Angle of Working Liquid at its Outflow, Wcf: Divided Load

1-2. (canceled)

3. A method for designing a cylinder device serving as a colloidal damper, the cylinder device comprising (A) a housing coupled to one of two objects which move relative to each other, (B) a piston coupled to another of the two objects and slidable in the housing, and (C) a porous body and working liquid contained inside a chamber defined by the housing and the piston, the porous body having a multiplicity of pores, the cylinder device being configured to (i) support an upper one of the two objects depending upon an internal pressure in the chamber which is produced by a state in which the working liquid has flowed in the multiplicity of pores of the porous body and (ii) damp relative movement between the two objects by utilizing a change in an amount of the working liquid flowing in the multiplicity of pores of the porous body, the change being caused by the relative movement between the two objects, the method comprising:
an initial-compression spring constant setting process in which an initial-compression spring constant is set, wherein the initial-compression spring constant is a rate of change in the internal pressure in the chamber with respect to an amount of stroke performed by the cylinder device until the working liquid starts to flow into the multiplicity of pores of the porous body; and
a working liquid amount determination process in which the working liquid is selected, a pressure receiving area of the piston is set, and the amount of the working liquid is determined based on a bulk modulus of the selected working liquid, the set pressure receiving area of the piston, and the set initial-compression spring constant and using a relationship in which the initial-compression spring constant is equal to a value obtained by dividing, by the amount of the working liquid, a product of the bulk modulus of the working liquid and a square of the pressure receiving area of the piston.

4. A method for designing a cylinder device serving as a colloidal damper, the cylinder device comprising (A) a housing coupled to one of two objects which move relative to each other, (B) a piston coupled to another of the two objects and slidable in the housing, and (C) a porous body and working liquid contained inside a chamber defined by the housing and the piston, the porous body having a multiplicity of pores, the cylinder device being configured to (i) support an upper one of the two objects depending upon an internal pressure in the chamber which is produced by a state in which the working liquid has flowed in the multiplicity of pores of the porous body and (ii) damp relative movement between the two objects by utilizing a change in an amount of the working liquid flowing in the multiplicity of pores of the porous body, the change being caused by the relative movement between the two objects, the method comprising:
an initial-compression spring constant setting process in which an initial-compression spring constant is set, wherein the initial-compression spring constant is a rate of change in the internal pressure in the chamber with respect to an amount of stroke performed by the cylinder device until the working liquid starts to flow into the multiplicity of pores of the porous body;
a bulk modulus determination process in which a pressure receiving area of the piston and the amount of the working liquid are set, and a bulk modulus is calculated and determined, as a designed bulk modulus, based on the set pressure receiving area of the piston, the set amount of the working liquid, and the set initial-compression spring constant and using a relationship in which the initial-compression spring constant is equal to a value obtained by dividing, by the amount of the working liquid, a product of a bulk modulus of the working liquid and a square of the pressure receiving area of the piston; and
a bulk-modulus adjustment material determination process in which a material to be contained in the chamber is determined to adjust, to the designed bulk modulus, a bulk modulus of the chamber which is an inverse of a change in capacity of the chamber with respect to a force applied to the chamber, the material having a bulk modulus which differs from that of the working liquid.

5. The method for designing the cylinder device according to claim 3, wherein in the initial-compression spring constant setting process, the initial-compression spring constant is set at a value less than a spring constant that is determined according to a bulk modulus of water.

6-9. (canceled)

10. The method for designing the cylinder device according to claim 4, wherein in the initial-compression spring constant setting process, the initial-compression spring constant is set at a value less than a spring constant that is determined according to a bulk modulus of water.
